(19) United States
(12) Patent Application Publication
(10) Pub. No.: US 2024/0012874 A1
(43) Pub. Date: Jan. 11, 2024

(54) COMPUTER-READABLE RECORDING MEDIUM STORING COMMUNICATION CONTROL PROGRAM, INFORMATION PROCESSING APPARATUS, AND COMMUNICATION CONTROL METHOD

(71) Applicant: Fujitsu Limited, Kawasaki-shi (JP)

(72) Inventor: Yosuke OYAMA, Kawasaki (JP)

(73) Assignee: Fujitsu Limited, Kawasaki-shi (JP)

(21) Appl. No.: 18/317,136

(22) Filed: May 15, 2023

(30) Foreign Application Priority Data
Jul. 8, 2022 (JP) 2022-110622

(51) Int. Cl. G06F 17/16

(52) U.S. Cl. CPC G06F 17/16

(57) ABSTRACT

A non-transitory computer-readable recording medium records a communication control program for causing a computer to execute a processing of: processing, by a plurality of information processing devices intercoupled by a multidimensional torus structure, blocks of a matrix in Distributed Block Compressed Sparse Row (DBCSR) format in a plurality of processes in a distributed manner; and communicating the blocks in both directions for each of a left matrix and a right matrix of the matrix at each stage of a matrix product algorithm.

### CROSS-REFERENCE TO RELATED APPLICATION

This application is based upon and claims the benefit of priority of the prior Japanese Patent Application No. 2022-110622, filed on Jul. 8, 2022, the entire contents of which are incorporated herein by reference.

### FIELD

The embodiment discussed herein is related to a computer-readable recording medium storing a communication control program, an information processing apparatus AND a communication control method.

### BACKGROUND

Many sparse matrix formats have been proposed to handle large and sparse matrices that frequently occur in scientific and technical calculations.

Japanese Laid-open Patent Publication No. 2013-161274, International Publication Pamphlet No. WO2021/009901, U.S. Patent Publication No. 2013/0339499 and U.S. Patent Publication No. 2020/0057652 are disclosed as related art.
Cannon, Lynn Elliot “A cellular computer to implement the Kalman filter algorithm”, [online], 1969, CVPR2021, [searched on Jun. 30, 2022], Internet <URL:https://scholarworks.montana.edu/xmlui/bitstream/handle/1/4168/317621 00054244.pdf?sequence=1> is disclosed as related art.

### SUMMARY

According to an aspect of the embodiments, a non-transitory computer-readable recording medium records a communication control program for causing a computer to execute a processing of: processing, by a plurality of information processing devices intercoupled by a multidimensional torus structure, blocks of a matrix in Distributed Block Compressed Sparse Row (DBCSR) format in a plurality of processes in a distributed manner; and communicating the blocks in both directions for each of a left matrix and a right matrix of the matrix at each stage of a matrix product algorithm.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a hardware configuration of a computer system as an example of an embodiment;

FIG. 2 is a diagram illustrating an interconnect with a multi-dimensional torus structure;

FIG. 3 is a diagram illustrating a functional configuration of each node of the computer system as an example of an embodiment.

FIG. 4 is a diagram illustrating objects held by each process in the computer system as an example of an embodiment;

FIG. 5 is a diagram illustrating a data structure of each object in the computer system as an example of an embodiment.

FIG. 6 is a diagram illustrating a data structure of a Distributed Block Compressed Sparse Row (DBCSR) matrix used in the computer system as an example of an embodiment;

FIG. 7 is a diagram illustrating details of array data of the DBCSR matrix in the computer system as an example of an embodiment.

FIG. 8 is a diagram illustrating a method of generating images by an image generation unit of the computer system as one example of an embodiment;

FIG. 9 is a diagram exemplifying a usage status of communication buffers when Cannon matrix product algorithm is executed in the computer system as an example of an embodiment.

FIG. 10 is a diagram for explaining an outline of processing by a matrix product calculation unit of the computer system as an example of an embodiment;

FIG. 11 is a diagram for explaining an outline of processing by the matrix product calculation unit of a computer system as an example of an embodiment.

FIG. 12 is a flowchart for explaining processing of an image generation unit of the computer system as one example of an embodiment;

FIG. 13 is a flowchart for explaining processing of a communication buffer reservation processing unit of the computer system as one example of an embodiment;

FIG. 14 is a flowchart for explaining the details of step B3 in FIG. 13;

FIG. 15 is a flowchart for explaining an outline of processing of the matrix multiplication unit of the computer system as one example of an embodiment;

FIG. 16 is a flowchart for explaining processing of steps C3 and C5 of FIG. 15;

FIG. 17 is a flowchart for explaining processing of steps C4 and C6 of FIG. 15;

FIG. 18 is a flowchart for explaining processing of step C7 in FIG. 15;

FIG. 19 is a diagram illustrating processing in the computer system as an example of an embodiment;

FIG. 20 is a diagram illustrating processing in the computer system as an example of an embodiment;

FIG. 21 is a diagram illustrating processing in the computer system as an example of an embodiment;

FIG. 22 is a diagram illustrating processing in the computer system as an example of an embodiment;

FIG. 23 is a diagram illustrating processing in the computer system as an example of an embodiment;

FIG. 24 is a diagram illustrating processing in the computer system as an example of an embodiment;

FIG. 25 is a diagram illustrating processing in the computer system as an example of an embodiment;

FIG. 26 is a diagram illustrating processing in the computer system as an example of an embodiment;

FIG. 27 is a diagram illustrating an example of applying a communication control method to Density Functional Theory (DFT) calculation of 32 water molecules (96 atoms) using CP2K application.

FIG. 28 is a diagram for explaining Cannon matrix product algorithm.

FIG. 29 is a diagram illustrating substeps of multiply_cannon function.

FIG. 30 is a conceptual diagram of a timeline of the multiply_cannon function.

### DESCRIPTION OF EMBODIMENTS

The DBCSR format, which is one of the sparse matrix formats, divides a matrix into a two-dimensional block grid, stores a position of each non-zero block in CSR (Compressed Row Storage) sparse matrix format, and distributes contents of blocks among processes as a dense matrix.

The Cannon matrix product algorithm is known as a method of calculating the matrix multiplication of DBCSR matrices with each other.

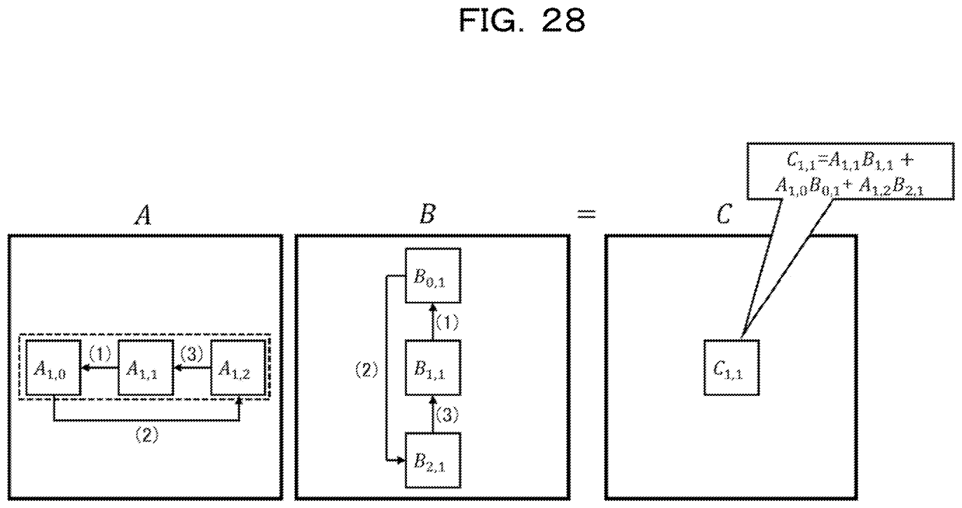

FIG. 28 is a diagram for explaining Cannon matrix product algorithm.

The Cannon matrix product algorithm is a method to calculate the product of two matrices distributed in two-dimensional processes. The following one step S1 to S3 is repeated while the process (i, j) on the two-dimensional upper process space N×N holds A_{i,k} and B_{k,j} (k=i+j mod N) of block matrices A and B, to obtain Ci,j of an equation C=AB.

In the equation C=AB, the matrix A is hereinafter referred to as the left matrix and the matrix B is hereinafter referred to as the right matrix. Also, the right matrix and the left matrix may be referred to as left and right matrices.

S1: C_{i,j}+=(A's block possessed)(B's block possessed)

S2: Cycle A's block possessed for one process within the same block row

S3: Cycle B's block possessed for one process within the same block column

Note that this Cannon matrix product algorithm assumes that the two-dimensional grid of the process and the two-dimensional grid of the matrix block match.

A function (multiply_cannon function) for calculating a matrix product by such the Cannon matrix product algorithm is known.

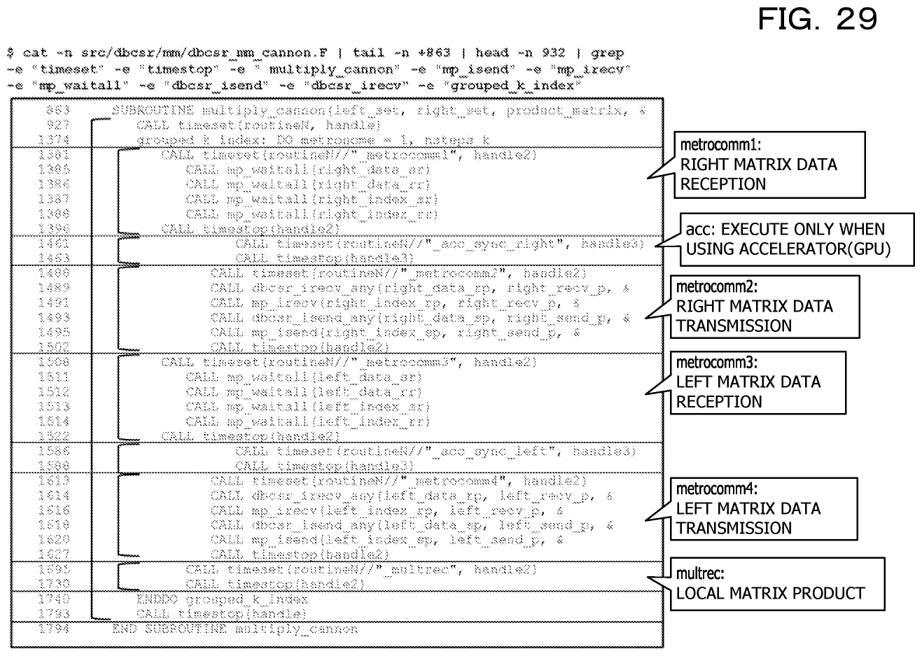

FIG. 29 is a diagram illustrating the substeps of the multiply_cannon function.

As shown in FIG. 29, the multiply_cannon function includes metrocomm{1,4} and multrec.

In multrec, a process-local block-matrix product is computed. Further, in metrocomm{1,4}, left-right matrix communication processing is performed. For example, right matrix data reception processing is performed in metrocomm1, and right matrix data transmission processing is performed in metrocomm2. Left matrix data reception processing is performed in metrocomm3, and left matrix data transmission processing is performed in metrocomm4.

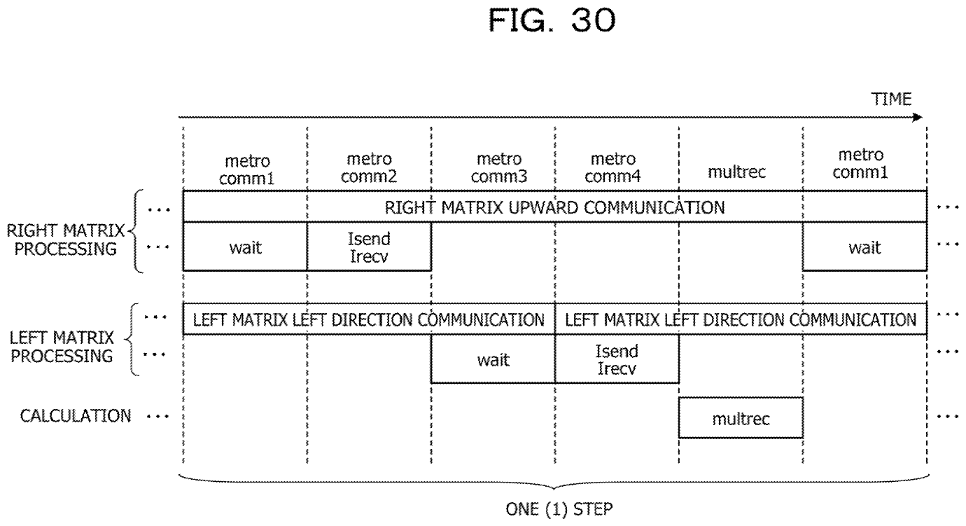

FIG. 30 is a conceptual diagram of the timeline of the multiply_cannon function.

In FIG. 30, an arrow pointing to the right indicates the passage of time. FIG. 30 indicates that one step of processing in which metrocomm1, metrocomm2, metrocomm3, metrocomm4 and multrec are performed in this order is repeated.

Right matrix communication is started in metrocomm2 (Isend, Irecv) and waits until completion of metrocomm1 which is a next step (wait). The left matrix communication is started at metrocomm4 (Isend, Irecv) and waits until completion of metrocomm3 which is a next step (wait).

However, in the multiply_cannon function, when the matrix is subdivided, the processing of metrocomm{1,4} increases, and the overhead of communication start/completion increases relatively, resulting in performance degradation.

For example, in a strong scaling condition where the application problem size (matrix size) is fixed and the number of processes is increased, the number of processes is increased for the same matrix size and the cost of matrix multiplication is increased.

For example, if the number of processes is too large with respect to the matrix size, the overhead of each communication step in the Cannon matrix product algorithm becomes apparent, causing performance degradation.

In one aspect, an object of the present embodiment is aim to improve the processing performance of the DBCSR matrix.

Embodiments of a communication control program, an information processing apparatus, and a communication control method will be described below with reference to the drawings. However, the embodiments illustrated below are merely examples, and there is no intend to exclude various modifications and application of techniques, which are not explicitly described in the embodiments. For example, the present embodiment may be modified in various ways without departing from the spirit of the embodiments. Also, each drawing does not mean that it has only the constituent elements illustrated in the drawing, but may include other functions and the like.

(A) Configuration

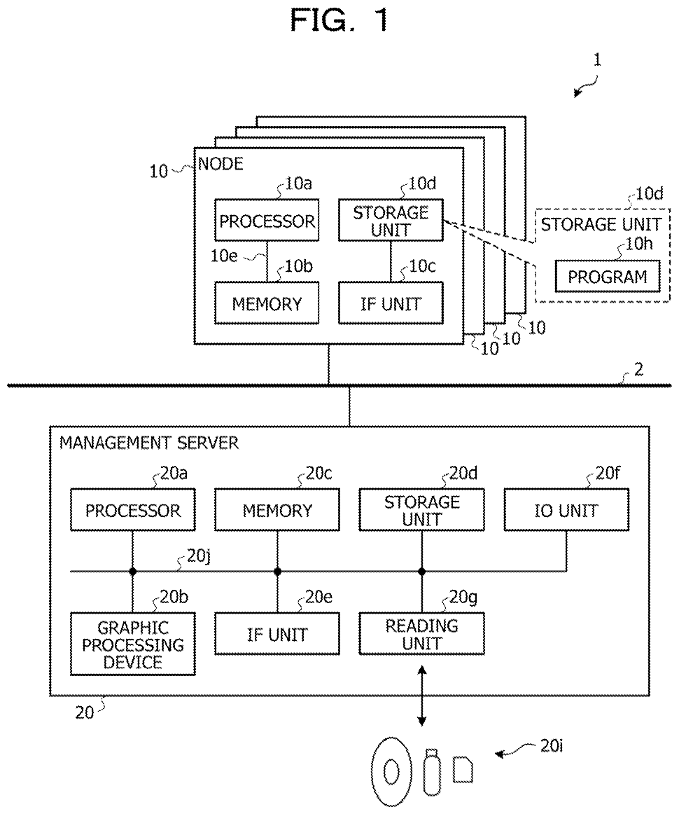

FIG. 1 is a diagram illustrating a hardware configuration of a computer system as an example of an embodiment.

A computer system 1 illustrated in FIG. 1 includes a plurality of nodes 10. A node 10 is an independent computer (information processing device, computer) on which one or more processes are executed. These nodes 10 are coupled via the network 2 so as to be able to communicate with each other.

A network 2 may be an interconnect with a multi-dimensional torus structure. The computer system 1 may be a supercomputer or cluster employing a multi-dimensional torus interconnect.

In addition, the computer system 1 calculates a matrix product between DBCSR sparse matrices requested by a parallel computing application operating on a two-dimensional grid.

The computer system 1 corresponds to an information processing device system in which a plurality of nodes (information processing devices) 10 interconnected by a multidimensional torus structure process blocks of a matrix in DBCSR format in a plurality of processes in a distributed manner.

The parallel computing application (hereinafter simply referred to as an application) may be, for example, a Message Passing Interface (MPI) application.

In the computer system 1, the Cannon matrix product algorithm may be used as a method of calculating the matrix multiplication of the DBCSR matrices.

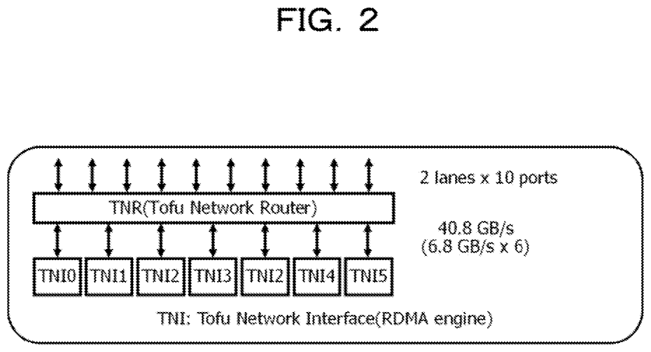

FIG. 2 is a diagram illustrating an interconnect using a multi-dimensional torus structure.

Since the network 2 may overlap communications efficiently, an interface that may simultaneously communicate with nodes 10 in four or more directions is desirable. For example, it may be a Tofu interconnect D of sixth dimensional (6D) mesh/torus coupling exemplified in FIG. 2.

Each node 10 may have a similar hardware configuration. As shown in FIG. 1, each node 10 may include a processor 10a, a memory 10b and an Interface (IF) unit 10c as a hardware configuration.

The processor 10a is an example of an arithmetic processing device that performs various controls and operations. The processor 10a may be communicably coupled to each block in the node 10 via a bus 10e with each other. Note that the processor 10a may be a multiprocessor including a plurality of processors, a multicore processor having a plurality of processor cores, or a configuration having a plurality of multicore processors.

Examples of the processor 10a include integrated circuits (IC) such as CPU, MPU, APU, DSP, ASIC, and FPGA. A combination of two or more of these integrated circuits may be used as the processor 10a. CPU is an abbreviation for Central Processing Unit, and MPU is an abbreviation for Micro Processing Unit. APU is an abbreviation for Accelerated Processing Unit. DSP is an abbreviation for Digital Signal Processor, ASIC is an abbreviation for Application Specific IC, and FPGA is an abbreviation for Field-Programmable Gate Array.

The memory 10b is an example of hardware that stores information such as various data and programs. Examples of the memory 10b include one or both of a volatile memory such as a Dynamic Random Access Memory (DRAM) and a nonvolatile memory such as a Persistent Memory (PM).

The storage unit 10d may store a program 10h (a communication control program) that implements all or part of various functions of the node 10.

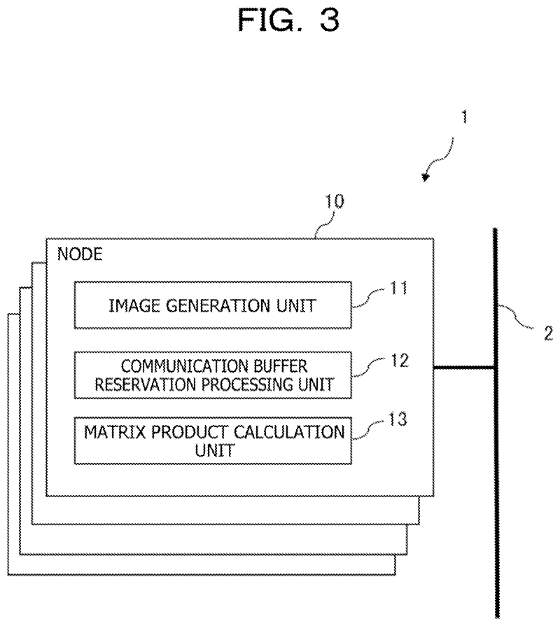

For example, the processor 10a of the node 10 may implement a communication control function, which will be described later, by expanding the program 10h stored in the storage unit 10d into the memory 10b and executing the program 10h. Further, the storage unit 10d may store various data generated by each unit (see FIG. 3) that implements the function of the node 10 in the course of processing.

The IF unit 10c is an example of a communication IF that controls connection, communication and the like between the node 10 and other nodes 10 or a management server 20, which will be described later. For example, the IF unit 10c may include an interconnect-compliant adapter. The IF unit 10c may include an adapter conforming to Local Area Network (LAN) such as Ethernet (registered trademark), optical communication such as Fibre Channel (FC) or the like. The adapter may support one or both of wireless and wired communication methods.

For example, the node 10 may be coupled to other nodes 10 and the management server 20 via the IF unit 10c and the network 2 so as to be able to communicate with each other. Note that the program 10h may be downloaded from the network 2 to the node 10 via the communication IF and stored in the storage unit 10d. Node 10 may be coupled to management server 20 via network 2.

The management server 20 manages the communication control program executed by each node 10, provides the program (communication control program) executed by each node 10 to each node 10 as necessary, and causes each node 10 to install the program.

As illustrated in FIG. 1, the management server 20 has, as an exemplary hardware configuration, a processor 20a, a graphic processing device 20b, a memory 20c, a storage unit 20d, an IF unit 20e, an Input/Output (IO) unit 20f, and a reading unit 20g may be provided.

The processor 20a is an example of an arithmetic processing device that performs various controls and operations. The processor 20a may be communicably coupled to each block in the management server 20 mutually via a bus 20j. Note that the processor 20a may be a multiprocessor including a plurality of processors, a multicore processor including a plurality of processor cores, or a configuration including a plurality of multicore processors.

Examples of the processor 20a include integrated circuits such as CPU, MPU, APU, DSP, ASIC, and FPGA. A combination of two or more of these integrated circuits may be used as the processor 20a.

The graphics processing device 20b performs screen display control for an output device such as a monitor in the IO unit 10f. The graphics processing device 20b includes various arithmetic processing devices such as Graphics Processing Units (GPUs), APUs, DSPs, integrated circuits (ICs) such as ASICs or FPGAs.

The memory 20c is an example of hardware that stores information such as various data and programs. Examples of the memory 20c include one or both of a volatile memory such as a DRAM and a nonvolatile memory such as PM.

The storage unit 20d is an example of hardware that stores information such as various data and programs. Examples of the storage unit 20d include magnetic disk devices such as a hard disk drive (HDD), semiconductor drive devices such as a solid state drive (SSD), and various storage devices such as nonvolatile memories. Examples of nonvolatile memory include a flash memory, a storage class memory (SCM), a read only memory (ROM), and the like.

The storage unit 20d may store a program that implements all or part of various functions of the management server 20. For example, the processor 20a of the management server 20 may realize various functions by loading the program 10h stored in the storage unit 20d into the memory 20c and executing the program.

A program (communication control program) executed by each node 10 may be stored in the storage unit 20d, and the management server 20 may transmit this program to each node 10.

The IF unit 20e is an example of a communication IF that controls connections, communications and the like between the management server 20 and each node 10. For example, the IF unit 10c may include an interconnect-compliant adapter. The IF unit 10c may include an adapter conforming to LAN such as Ethernet or optical communication such as FC. The adapter may support one or both of wireless and wired communication methods.

For example, the management server 20 may be coupled to each of the plurality of nodes 10 via the IF unit 20e and the network 2 so as to be able to communicate with each other.

The IO unit 20f may include one or both of an input device and an output device. Examples of the input device includes, for example, a keyboard, a mouse, a touch panel or the like. Example of the output device include a monitor, a projector, a printer or the like. Also, the IO unit 20f may include a touch panel or the like in which an input device and a display device are integrated. The output device may be coupled to the graphics processing device 20b.

The reading unit 20g is an example of a reader that reads data and program information recorded on the recording medium 20i. The reading unit 20g may include a connection terminal or a device to which the recording medium 20i may be coupled or inserted. Examples of the reading unit 20g include an adapter conforming to Universal Serial Bus (USB) or the like, a drive device for accessing a recording disk, and a card reader for accessing flash memory such as a Secure Digital (SD) card. The program 10h executed by each node 10 may be stored in the recording medium 20i, and the reading unit 20g may read the program 20h from the recording medium 20i and store the program in the storage unit 20d.

Examples of the recording medium 20i include non-temporary computer-readable recording media such as magnetic/optical disks and flash memory. Examples of magnetic/optical discs include flexible discs, Compact Discs (CDs), Digital Versatile Discs (DVDs), Blu-ray discs, Holographic Versatile Discs (HVDs) or the like. Examples of flash memories include semiconductor memories such as USB memories and SD cards.

Each hardware configuration of the node 10 and the management server 20 described above is an example. Therefore, the hardware within the node 10 and the management server 20 may be increased or decreased (for example, addition or deletion of arbitrary blocks), division, integration in any combination, addition or deletion of buses, or the like may be performed as appropriate.

FIG. 3 is a diagram illustrating the functional configuration of each node 10 of the computer system 1 as an example of an embodiment.

As illustrated in FIG. 3, each node 10 may have functions as an image generation unit 11, a communication buffer reservation processing unit 12 and a matrix product calculation unit 13. These functions may be realized by the hardware of the node 10 (see FIG. 1).

Each node 10 executes one or more processes. Processes perform synchronization and data exchange between processes by communication in an execution state of programs that operate independently of each other.

A communication portion of a process may be written in MPI in an application.

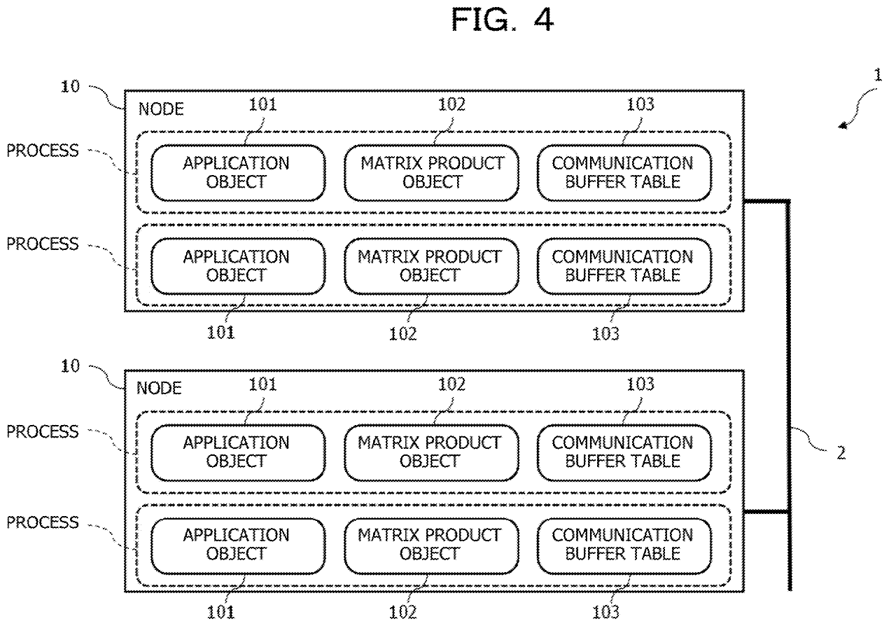

FIG. 4 is a diagram illustrating objects held by each process in the computer system 1 as an example of an embodiment.

As illustrated in FIG. 4, each process has an application object 101, a matrix product object 102 and a communication buffer table 103. For example, the application object 101, the matrix product object 102 and the communication buffer table 103 are managed for each process.

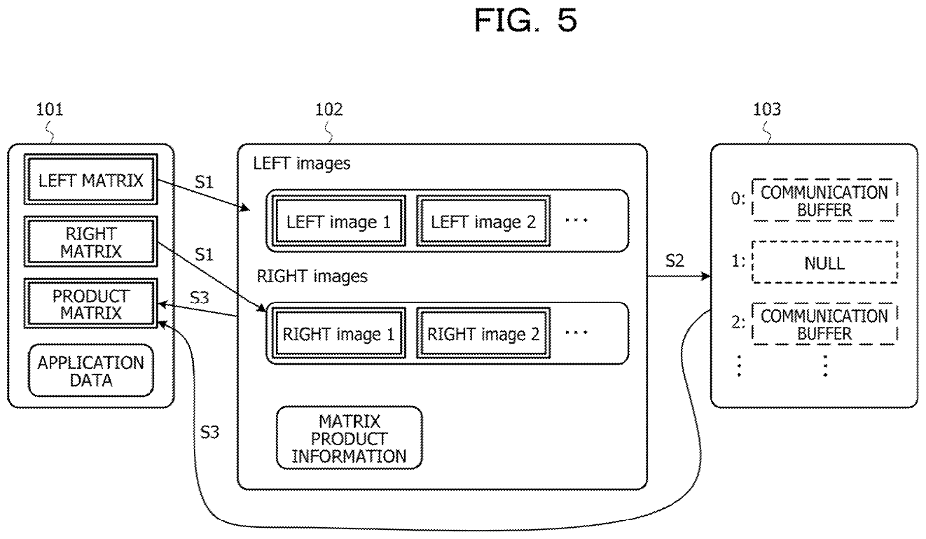

FIG. 5 is a diagram illustrating a data structure of each object in the computer system 1 as an example of the embodiment.

The application object 101 holds application level data including input/output matrices of matrix products. As illustrated in FIG. 5, the application object 101 includes a left matrix, a right matrix, a product matrix and application data.

The matrix product object 102 is created for each matrix product to hold the data being calculated. The matrix product object 102 holds matrix product data for each image generated by the image generation unit 11, which will be described later. In the example illustrated in FIG. 5, a plurality of left images (left image1, left image2, . . . ) generated based on the left matrix and a plurality of right images (right image1, right image2, . . . ) generated based on the right matrix are illustrated.

The communication buffer table 103 holds communication buffers in a hash table and holds data until the end of the application.

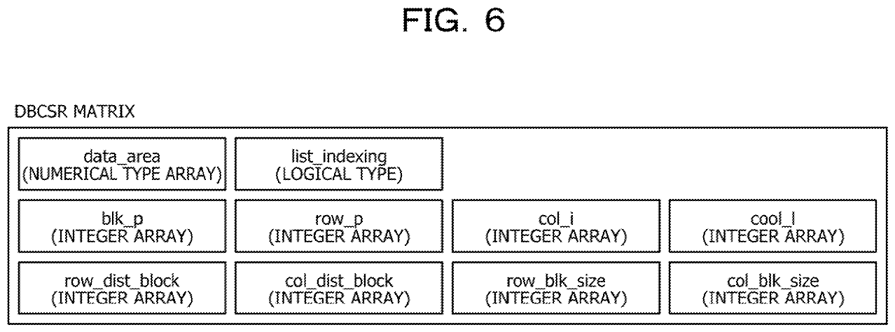

FIG. 6 is a diagram illustrating a data structure of a DBCSR matrix used in the computer system 1 as an example of an embodiment.

The DBCSR matrix holds arrays representing data of non-zero blocks of and a structure of the matrix. The DBCSR matrix illustrated in FIG. 6 includes data_area, list_indexing, blk_p, row_p, col_i, coo_l, {row, col}_dist_block and {row, col}_blk_size.
data_area is a column-major or row-major concatenation of the non-zero blocks. For a numerical type, a type used for calculation is specified by an application at the time of initialization. For example, a double precision floating point type may be used.
list_indexing represents a sparse matrix format, COO format is used in a case of being true (TRUE) and CSR format is used in a case of being false (FALSE).
blk_p represents a starting position in data_area for each block, and is used when CSR format is used.
row_p and col_i represent non-zero block positions and are used when using the CSR format.
coo_l represents a non-zero block position, for example, represents a row position, a column position and a repeat data_area offset. coo_l is used when using the COO format.
{row,col}_dist_block is a mapping to a process grid and includes row_dist_block and col_dist_block. {row,col}_blk_size is a row/column block size and includes row_blk_size and col_blk_size.

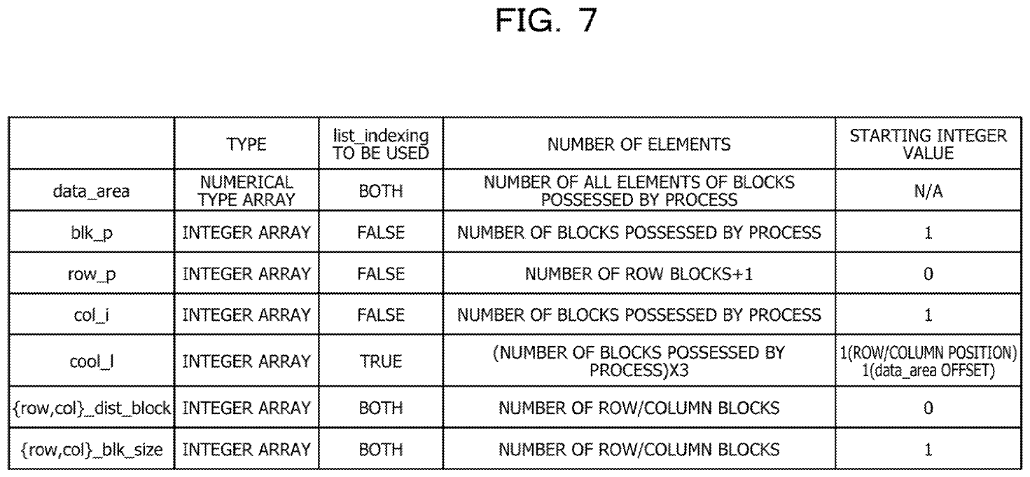

FIG. 7 is a diagram illustrating a detail of array data held by the DBCSR matrix in the computer system 1 as an example of the embodiment.

In FIG. 7, for each array, the type, list_indexing to be used, a number of elements, and a starting integer value are illustrated.

In the DBCSR matrix, the process grid does not necessarily correspond to a matrix block grid, so the Cannon matrix product algorithm may not be applied directly to an input matrix.

For example, the process grid is not necessarily a square matrix, so a number of processes in the row direction of the left matrix does not necessarily match the number of processes in the column direction of the right matrix.

Also, a column process index of the left matrix and a row process index of the right matrix do not necessarily match.

Therefore, in the computer system 1, the image generator 11 generates a set of images (hereinafter referred to as images) consisting of one or more DBCSR matrices for each of the left and right matrices.

The image generation unit 11 may use a known technique to convert the DBCSR matrix into images. For example, the image generation unit 11 may perform conversion into images using the technique described in the following literature.
Urban Borstnik, J. VandeVondele, V. Weber, J. Hutter, Sparse matrix multiplication: The distributed block-compressed sparse row library, Parallel Computing, Volume 40, Issues 5-6, 2014, Pages 47-58, ISSN 0167-8191, <https://www.sciencedirect.com/science/article/abs/pii/S0167819114000428>

Images after conversion are a list of the one or more DBCSR matrices and satisfy the following properties.
(1) A number of left images is (the least common multiple of a number of process grid columns and a number of process grid rows)/(the number of process grid rows)
(2) A number of right images is (the least common multiple of the number of process grid columns and the number of process grid rows)/(the number of process grid columns)
(3) For each of the left and right images, a sum of all images possessed by all processes is equal to an original matrix.
(4) Transform moves the non-zero blocks to any image in any process.
(5) {row,col}_blk_size does not change.
(6) row_dist_block of the left matrix and col_dist_block of the right matrix do not change.

For example, the image generation unit 11 decomposes the right and left matrices into sums (images) of the one or more DBCSR matrices using a known images conversion function (dbcsr_multiply_generic function), and performs block exchange to convert the right and left matrices to images.

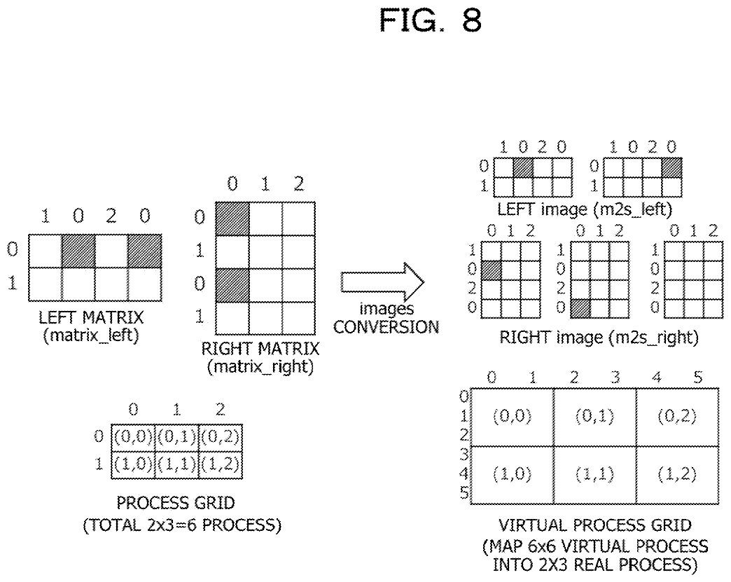

FIG. 8 is a diagram illustrating a method of generating images by the image generation unit 11 of the computer system 1 as an example of the embodiment.

In the example illustrated in FIG. 8, the image generation unit 11 sets a 2×3 process grid as a 6×6 process grid virtually using the images conversion function, and decomposes the left matrix into two images and the right matrix into three images.

The communication buffer reservation processing unit 12 manages the communication buffers using the communication buffer table 103. The communication buffer table 103 is a hash table that manages the communication buffers by associating the communication buffers with hash values calculated based on the DBCSR matrix.

For each of the left and right matrices, the communication buffer reservation processing unit 12 reserves (acquires pointers of) transmission/reception buffers for forward direction communication and reception buffers and transmission buffers for reverse direction communication as communication buffers in the communication buffer table 103.

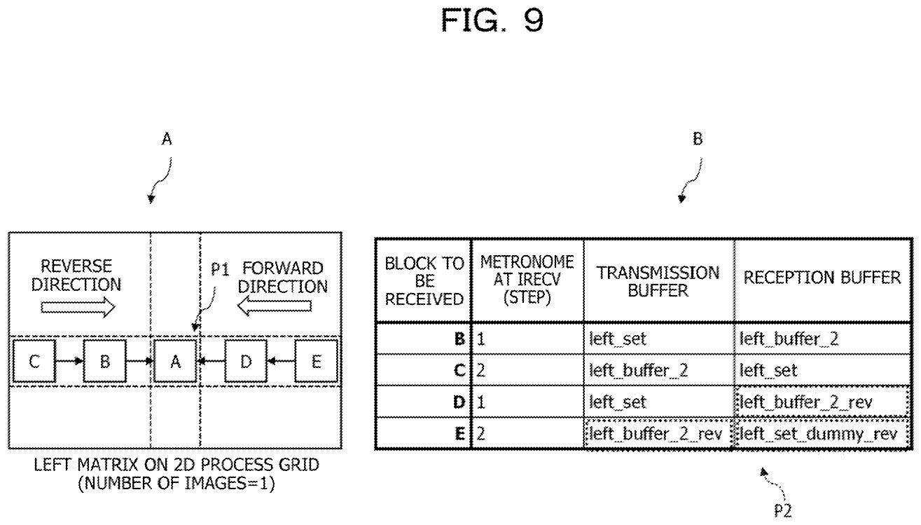

For example, for each of the left and right matrices, the communication buffer reservation processing unit 12 secures one buffer for the forward direction communication (left_buffer_2 in FIG. 9 in the example of the left matrix) and two buffers for the reverse direction communication (left_buffer_2_rev and left_set_dummy_rev in FIG. 9 in the example of the left matrix), respectively.

The three communication buffers secured for each of the left and right matrices are used as the transmission/reception buffers for the forward direction communication and transmission/reception buffers for the reverse direction communication.

When the communication buffer table 103 does not contain any buffer that may be reserved, the communication buffer reservation processing unit 12 generates a new communication buffer, stores the new communication buffer in the communication buffer table 103, and then uses the new communication buffer.

On the other hand, if the DBCSR matrix previously used a communication buffer, the communication buffer reservation processing unit 12 uses (reuses) the same communication buffer.

Here, the communication buffer reservation processing unit 12 manages communication buffers using a hash table for each process. For example, when securing a communication buffer pointer, the communication buffer reservation processing unit 12 calculates a hash value from the matrix and checks whether a communication buffer having a matching hash value exists in the communication buffer table 103. If the communication buffer having the matching hash value exits in the communication buffer table 103, next, the communication buffer reservation processing unit 12, if the matrix and the key of the communication buffer having the matching hash value match, sets the communication buffer having the matching hash value as a buffer to be used.

Note that the hash table may be stored in any manner, and for example, an open address method (open address method) may be used.

For example, the communication buffer reservation processing unit 12 reserves communication buffers in the communication buffer table 103 (hash table) for each process in association with hash values calculated based on the DBCSR matrix. Further, when a communication buffer for a DBCSR matrix with the matching hash value is registered in the communication buffer table 103 (hash table), the communication buffer reservation processing unit 12 reserves the registered communication buffer.

The key of the table may be a hash value whose input is a value that summarizes the matrix. For example, at least any one of a buffer type (0 to 5 integers of left matrix forward direction, left matrix inverse direction 1, left matrix inverse direction 2, right matrix forward direction, right matrix inverse direction 1 and right matrix inverse direction), a row/column size, a number of elements in a integer array that a matrix has and a number of elements of data_area of the matrix may be input.

A hash function is arbitrary. For example, the hash function may return an operation of adding the aforementioned input value to a product of a preceding hash value and an appropriate prime number.

For example, when using the buffer type and the row/column size, the key may be calculated using a following formula (1).

[Key]=((buffer type)×3+(row size))×5+(column size) (1)

A matching determination of the key between the left and right matrix and the communication buffer in the table is performed by whether the number of elements and values of all integer arrays except data_area match.

FIG. 9 is a diagram illustrating a usage of communication buffers when the Cannon matrix product algorithm is executed in the computer system 1 as an example of an embodiment.

In FIG. 9, a symbol A indicates a left matrix on a two-dimensional process grid and indicates an example of image number=1. A symbol B indicates a block to be received, metrocomm (step) in Irecv, a transmission buffer and a reception buffer to be used for a process (see code P1) that has A of the left matrix at the beginning of the two-dimensional process grid indicated by symbol A.

In the diagram indicated by symbol B in FIG. 9, the communication buffers (left_buffer_2_rev, left_buffer_2_rev, left_set_dummy_rev) enclosed in the dotted frame are used for the matrix product calculation unit 13 described later to communicate blocks in both directions on a forward direction and a reverse direction for each of the left and right matrices at each step of the Cannon matrix product algorithm.

For example, the communication buffer reservation processing unit 12 reserves communication buffers for the forward communication and reverse communications, since the matrix product calculation unit 13 performs double buffering in asynchronous communication of adjacent communication.

Since the reception buffer for the reverse direction communication (left_set_dummy_rev (see symbol P2) in symbol B in FIG. 9) is not used in the first step, an initialization overhead may be hidden in communication time by initializing the buffer at the end of the first step.

The matrix product calculation unit 13 uses the left and right images and the communication buffer table 103 to write the multiplication result into the output matrix (product matrix).

The matrix product calculation unit 13 bidirectionally communicates the blocks for each of the left and right matrices at each step of the Cannon matrix product algorithm. In addition, the matrix product calculation unit 13 repeats a communication step of the left and right matrices for all images at each step of the Cannon matrix product algorithm.

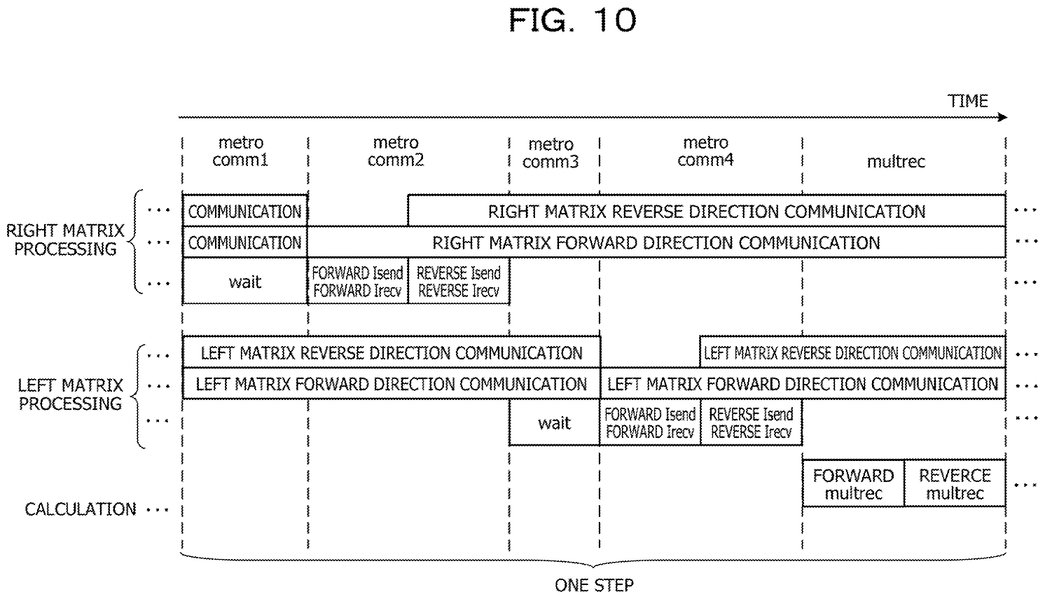

Each block is duplicated in two and two processes are moved per step, so a total number of steps is halved compared to the related method illustrated in FIG. 30. FIG. 10 is a diagram for explaining an overview of processing by the matrix product calculation unit 13 of the computer system 1 as an example of the embodiment.

In FIG. 10, arrows pointing to the right indicate a passage of time. FIG. 10 indicates that one step of processing performed in the order of metrocomm1, metrocomm2, metrocomm3, metrocomm4, and multrec is repeatedly executed.

Hereinafter, the communication direction (the direction in which a number of rows or columns decreases) in the related Cannon matrix product algorithm illustrated in FIG. 30 is assumed to be the forward direction and a reverse direction of the forward direction is assumed to be the reverse direction.

The matrix product calculation unit 13 communicates blocks in both of the forward and reverse directions for each of the left and right matrices at each step of the Cannon matrix product algorithm.

Each block is replicated in two, and are moved over two processes per step. As a result, the total number of steps is reduced by about half compared to the related method illustrated in FIG. 10.

This method is particularly effective under strong scaling conditions where a matrix size is small and bidirectional x two-dimensional communication is possible.

In FIG. 10, the forward and reverse direction communication of the right matrix is started in metrocomm2 (forward Isend, forward Irecv, reverse Isend, reverse Irecv) and waits for completion in metrocomm1 which is a next step. Also, the forward and reverse direction communication of the left matrix is started at metrocomm4 (forward Isend, forward Irecv, reverse Isend, reverse Irecv) and waits until completion at metrocomm3 which is a next step.

In multrec, a forward block matrix multiplication (forward multrec) and a reverse block matrix multiplication (inverse multrec) are performed.

The matrix product calculation unit 13 calculates the matrix product by repeating communication and local matrix product [K/2] times based on the Cannon matrix product algorithm. K=(a number of multiplication direction processes)/((a minimum number of images) is established.

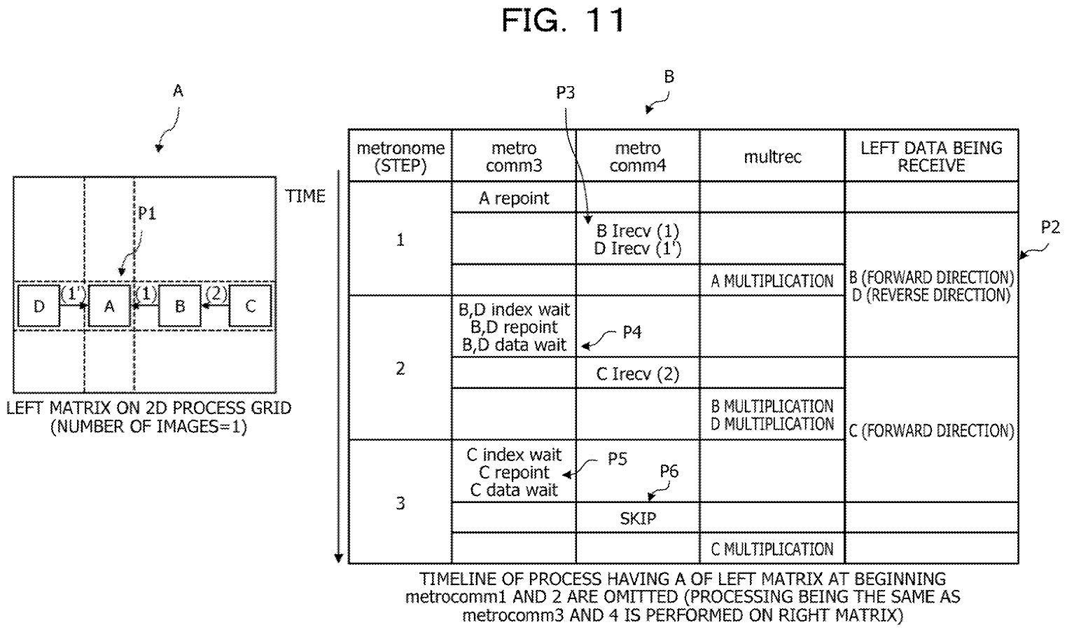

FIG. 11 is a diagram for explaining an overview of the processing by the matrix product calculation unit 13 of the computer system 1 as an example of the embodiment, and illustrates an example of processing of the left matrix.

In FIG. 11, symbol A indicates the left matrix on the two-dimensional process grid and an example of a number of images=1 is indicated. Symbol B indicates a timeline of processing performed by a process (see symbol P1) having A of the left matrix at the beginning of the two-dimensional process grid indicated by symbol A.

In FIG. 11, for the sake of convenience, only the processing of metrocomms3,4 and multrec is illustrated, and the processing of metrocomms1,2 is omitted. metrocomm1,2 performs the same processing as metrocomm3,4 on the right matrix.

Since the blocks are copied and moved in both directions, communications (1) and (2) corresponding to the related two steps occur in one step. In the process indicated by symbol P1, data B is received in the forward direction and data D is received in the reverse direction, respectively (see symbol P2). As a result, for example, in metrocomm4, reception of two blocks (B Irecv(1), D Irecv(1′)) is performed (see symbol P3).

In addition, in metrocomm3, a two-way reception wait (B, D data wait) is performed (see symbol P4).

(B) Operation

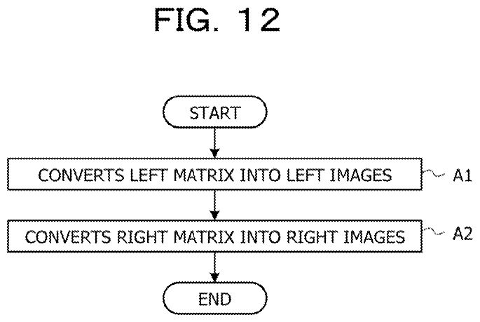

The processing of the image generation unit 11 of the computer system 1 as an example of the embodiment configured as described above will be described according to the flowchart (steps A1 to A2) illustrated in FIG. 12.

In step A1, the image generation unit 11 converts the left matrix into left images. Also, in step A2, the image generation unit 11 converts the right matrix into right images.

Note that the processing order of steps A1 and A2 is not limited to this. The process of step A1 may be performed after step A2. Further, the process of step A1 and the process of step A2 may be performed in parallel. After that, the process ends.

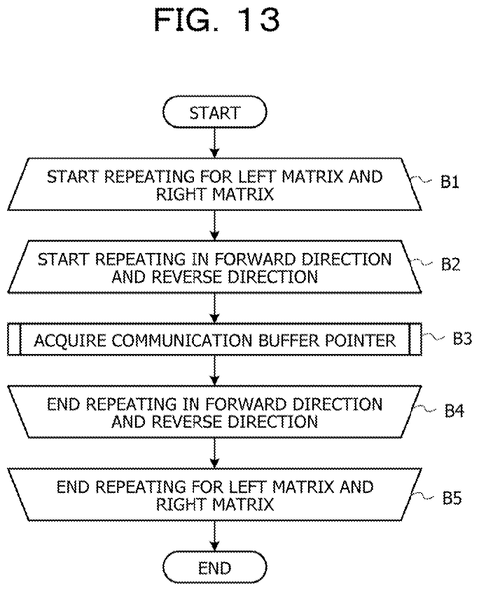

Next, processing of the communication buffer reservation processing unit 12 of the computer system 1 as an example of the embodiment will be described according to the flowchart (steps B1 to B5) illustrated in FIG. 13.

At step B1, a loop process is started in which a control up to step B5 is repeated for the left matrix and the right matrix.

In step B2, a loop process is started in which a control up to step B4 is repeatedly performed in the forward direction and the reverse direction.

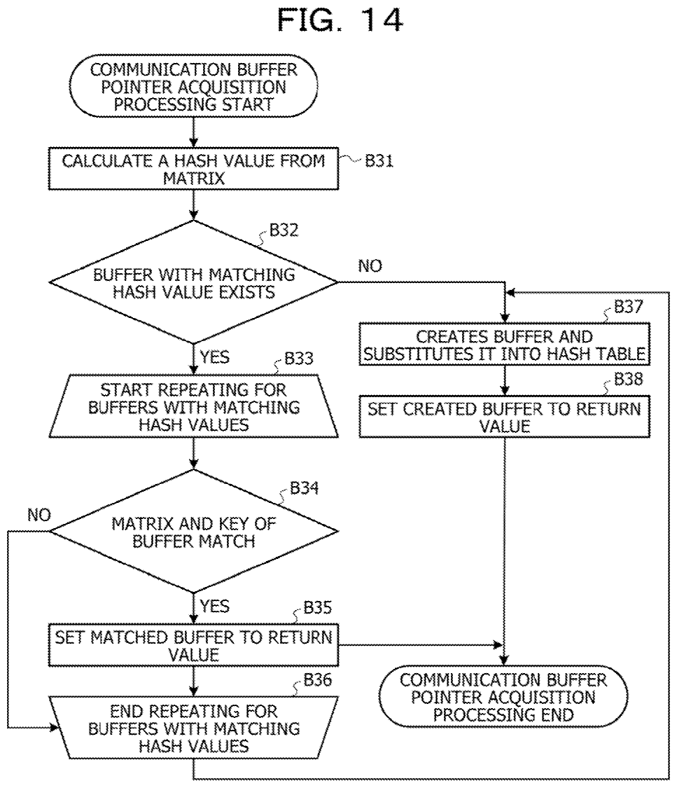

At step B3, the communication buffer reservation processing unit 12 performs an acquisition processing of a communication buffer pointer. Details of the processing of step B3 will be described later with reference to FIG. 14.

At step B4, loop end processing corresponding to step B2 is performed. Here, when forward and reverse processing are completed, control proceeds to step B5. In step B5, loop end processing corresponding to step B1 is performed. Here, when the processing of the left matrix and the right matrix is completed, this flow ends.

Next, the details of step B3 in FIG. 13 will be described according to the flowchart (steps B31 to B38) illustrated.

At step B31, the communication buffer reservation processing unit 12 calculates a hash value from the matrix.

At step B32, the communication buffer reservation processing unit 12 checks whether a communication buffer with a matching hash value exists in the communication buffer table 103. As a result of confirmation, if there is no communication buffer with the matching hash value in the communication buffer table 103 (see NO route in step B32), the process proceeds to step B37.

On the other hand, if a communication buffer with the matching hash value exists in the communication buffer table 103 as a result of the confirmation in step B32 (see YES route in step B32), the process proceeds to step B33.

In step B33, a loop process is started in which the control up to step B36 is repeated for all communication buffers with the matching hash values.

At step B34, the communication buffer reservation processing unit 12 confirms whether the matrix and the key of the communication buffer match. As a result of confirmation, if the matrix and the key of the communication buffer match (see YES route of step B34), the process proceeds to step B35.

In step B35, the communication buffer reservation processing unit 12 sets the communication buffer whose key matches to a return value. After that, the process ends.

Also, as a result of the confirmation in step B34, if the matrix and the key of the communication buffer do not match (see NO route in step B34), the process proceeds to step B36.

In step B36, loop end processing corresponding to step B33 is performed. Here, when the processing for all communication buffers with the matching hash values is completed, control proceeds to step B37.

In step B37, the communication buffer reservation processing unit 12 creates a new communication buffer and substitutes the new communication buffer into the hash table.

After that, in step B38, the communication buffer reservation processing unit 12 sets the generated communication buffer to the return value. After that, the process ends.

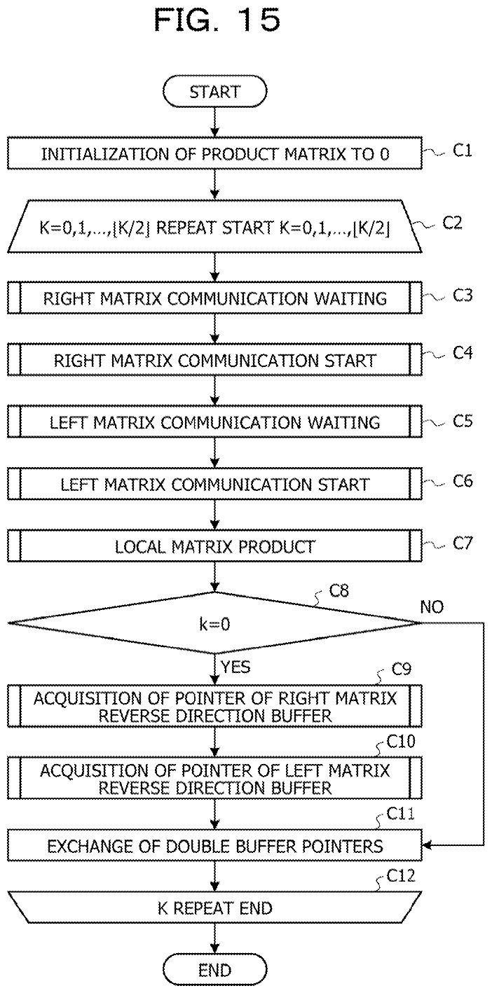

Next, an overview of the processing of the matrix product calculation unit 13 of the computer system 1 as an example of the embodiment will be described according to the flowchart (steps C1 to C12) shown in FIG. 15.

In step C1, the matrix product calculation unit 13 initializes the product matrix using 0 (zero initialization).

In step C2, a loop process is started to repeat the control up to step C12 while incrementing a value of k until k=K/2 is reached. Note that K=(the number of multiplication direction processes)/(the minimum number of images) is established.

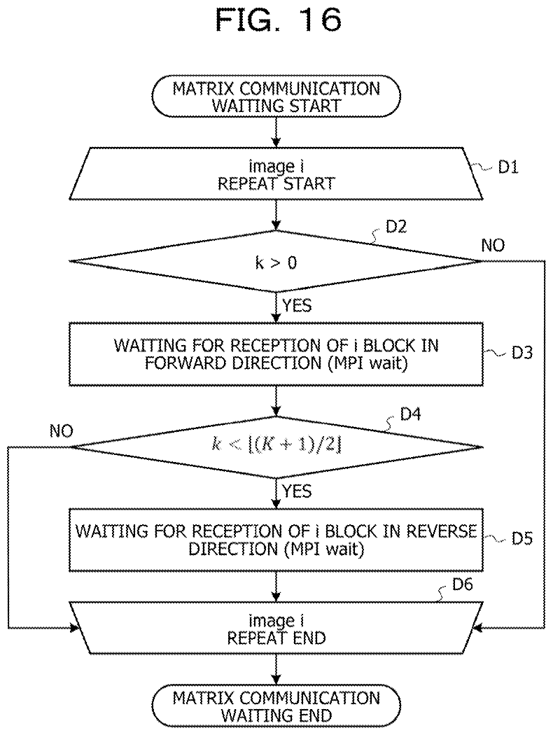

In step C3, the matrix product calculation unit 13 performs right matrix communication waiting processing. This right matrix communication waiting process corresponds to metrocomm1 in the Cannon matrix product algorithm. The details of this step C3 will be described later using the flowchart illustrated in FIG. 16.

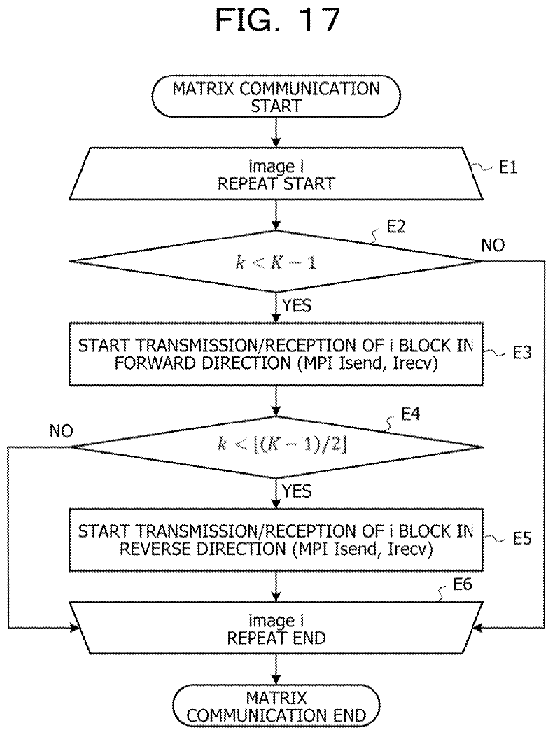

In step C4, the matrix product calculation unit 13 performs right matrix communication start processing. This right matrix communication start processing corresponds to metrocomm2 in the Cannon matrix product algorithm. The details of this step C4 will be described later using the flowchart illustrated in FIG. 17.

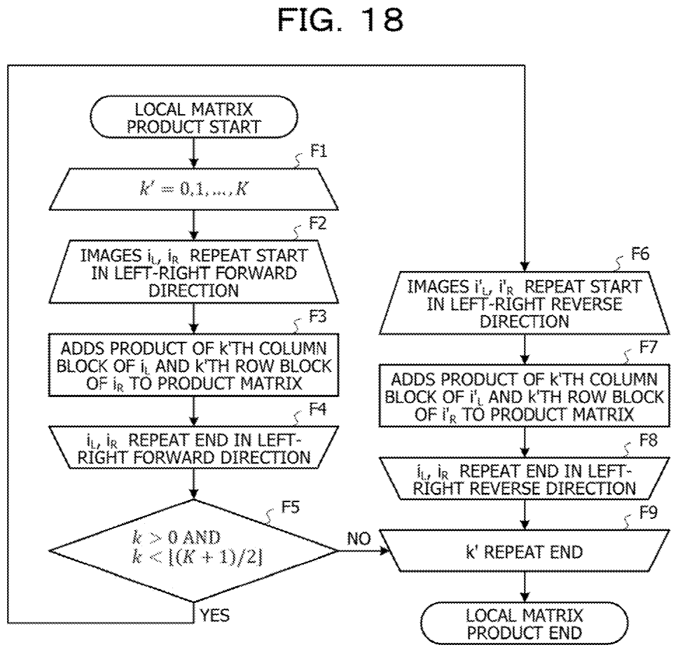

In step C5, the matrix product calculation unit 13 performs left matrix communication waiting processing. This left matrix communication waiting process corresponds to metrocomm3 in the Cannon matrix product algorithm. The details of this step C5 will be described later using the flowchart shown in FIG. 18.

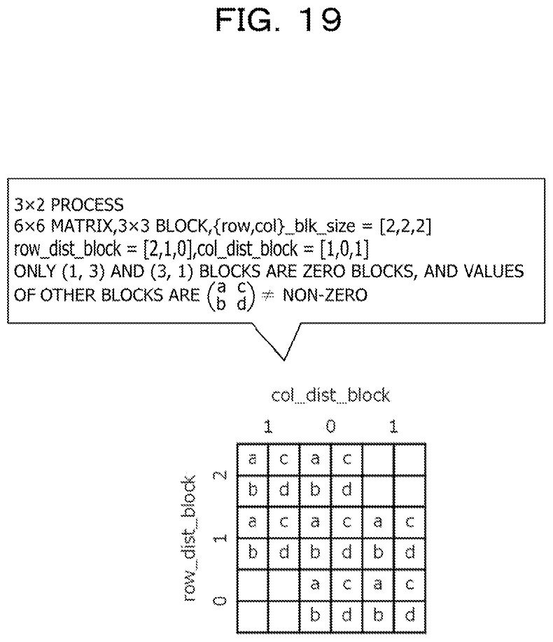

In step C6, the matrix product calculation unit 13 performs left matrix communication start processing. This left matrix communication start processing corresponds to metrocomm4 in the Cannon matrix product algorithm. The details of this step C6 will be described later using the flowchart shown in FIG. 19.

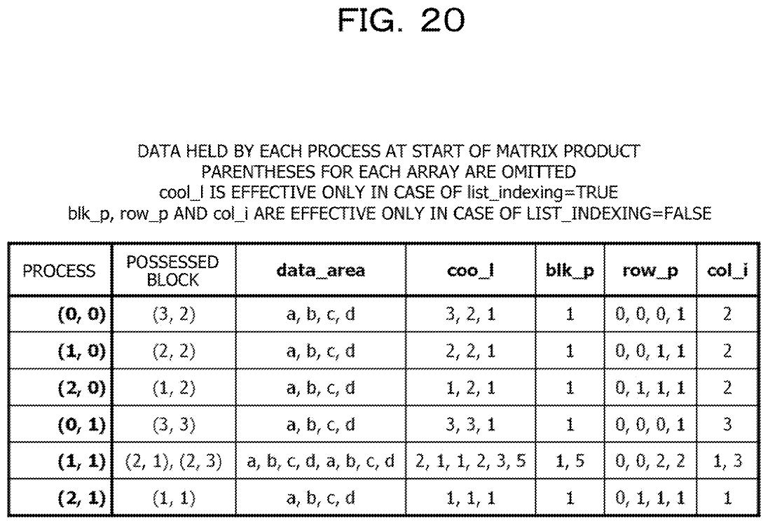

In step C7, the matrix product calculation unit 13 calculates a local matrix product. The process of calculating this local matrix product corresponds to multrec in the Cannon matrix product algorithm. The details of this step C7 will be described later using the flowchart shown in FIG. 20.

In step C8, the matrix product calculation unit 13 confirms whether k=0 is established. If k=0 is established (see YES route in step C8), for example, only for the first time, the subsequent steps C9 and C10 are executed.

In step C9, the matrix product calculation unit 13 acquires a pointer of the right matrix reverse direction buffer. The matrix product calculation unit 13 performs the same processing as the communication buffer pointer acquisition processing illustrated in FIG. 14.

In step C10, the matrix product calculation unit 13 acquires a pointer of the left matrix reverse direction buffer. The matrix product calculation unit 13 performs the same processing as the communication buffer pointer acquisition processing illustrated in FIG. 14.

In step C11, the matrix product calculation unit 13 exchanges double buffer pointers. For example, the matrix product calculation unit 13 exchanges pointers between the transmission buffer and the reception buffer. Also, if the result of confirmation in step C8 is not k=0 (see NO route in step C8), the process proceeds to step C11.

In step C12, loop end processing corresponding to step C2 is performed. Here, when k repetition processing is completed, the processing ends.

Next, the processing of steps C3 and C5 in FIG. 15 will be described according to the flowchart (steps D1 to D6) illustrated in FIG. 16. In the flow chart of matrix communication waiting processing illustrated in FIG. 16, the right and left matrices are similarly processed.

In step D1, loop processing is started to repeatedly perform the control up to step D6 for all generated images. An arbitrary image among the generated images is indicated by image i.

In step D2, the matrix product calculation unit 13 determines whether a number of steps k in the Cannon matrix product algorithm is greater than 0 (k>0). For example, the matrix product calculation unit 13 checks whether it is a first step in the Cannon matrix product algorithm. If k is greater than 0 (see YES route of step D2), for example, if it is not the first step in the Cannon matrix product algorithm, the process proceeds to step D3.

In step D3, the matrix product calculation unit 13 waits for reception of i block in the forward direction (MPI wait). In step D4, the matrix multiplication unit 13 determines whether or not it is necessary to wait for reception of the i block in the reverse direction. For example, the matrix product calculation unit 13 checks whether k<[(K+1)/2] is satisfied. As a result of checking, if k<[(K+1)/2] is satisfied (see YES route in step D4), it is not the last step in the Cannon matrix product algorithm. Therefore, in step D5, the matrix product calculation unit 13 waits for the reception of the i block in the reverse direction (MPI wait).

In step D6, loop end processing corresponding to step D1 is performed. Here, when the processing for all images is completed, the processing ends.

On the other hand, if k is 0 or less as a result of the confirmation in step D2 (see NO route in step D2), for example, in the first step in the Cannon matrix product algorithm, there is no need to wait for block reception. Therefore, the process moves to step D6.

Also, as a result of the confirmation in step D4, even if k<[(K+1)/2] is not satisfied (see NO route in step D4), the process also proceeds to step D6.

If it does not satisfy k<[(K+1)/2], that means that k corresponds to the last step in the Cannon matrix product algorithm. There is no need to wait for the block reception in such a last step. For example, in the timeline indicated by symbol B in FIG. 11, metrocomm3 waits to receive only the data block of data C as indicated by C data wait in the final step 3 (see symbol P5).

Next, the processing of steps C4 and C6 in FIG. 15 will be described according to the flowchart (steps E1 to E6) illustrated in FIG. 17. In the flowchart of the matrix communication start process illustrated in FIG. 17, the right matrix and the left matrix are also similarly processed.

In step E1, loop processing is started to repeatedly perform the control up to step E6 for all generated images. An arbitrary image among the generated images is indicated as image i.

In step E2, the matrix product calculation unit 13 determines whether the number of steps k in the Cannon matrix product algorithm is smaller than K−1 (k<K−1). For example, it is checked whether the final step in Cannon matrix product algorithm has been reached. If k is less than K−1 (see YES route of step E2), for example, if it is not the final step in the Cannon matrix product algorithm, then the process proceeds to step E3.

In step E3, the matrix product calculation unit 13 starts transmission/reception of i block in the forward direction (MPI Isend, Irecv). In step E4, the matrix product calculation unit 13 determines whether or not it is necessary to start the reception of i blocks in the reverse direction. For example, the matrix product calculation unit 13 checks whether or not k<[(k−1)/2] is satisfied. If the result of the check indicates that k<[(k−1)/2] is satisfied (see YES route in step E4), it is not the final step of the Cannon matrix product algorithm. Therefore, in step E5, the matrix product calculation unit 13 performs the transmission/reception of i block in the reverse direction (MPI Isend, Irecv).

In step E6, loop end processing corresponding to step E1 is performed. Here, when the processing for all images is completed, the processing ends.

On the other hand, if k is less than or equal to K−1 as a result of checking in step E2 (see NO route in step E2), for example, in the final step of the Cannon matrix product algorithm, it is not necessary to start the transmission/reception of the blocks. Therefore, the process moves to step E6.

Also, as a result of the confirmation in step E4, even if k<[(k−1)/2] is not satisfied (see NO route in step E4), the process proceeds to step E6.

If k<[(k−1)/2] is not satisfied, that indicates that k corresponds to the final step of the Cannon matrix product algorithm. In such a final step, there is no need to start the transmission/reception of the blocks. For example, in the timeline illustrated by symbol B in FIG. 11, metrocomm4 does not start transmission/reception of data blocks in the final step 3, as indicated by skip (see symbol P6).

Next, the processing of step C7 in FIG. 15 will be described according to the flowchart (steps F1 to F9) illustrated in FIG. 18.

In step F1, a loop process is started in which the control up to step F9 is repeated while incrementing the value of k′ until K is reached. Note that K=(the number of multiplication direction processes)/((the minimum number of images) is established. Any value of K is denoted by k′.

In step F2, a loop process is started in which the control up to step F4 is repeated for all images in the left-right forward direction. Note that the image of the left matrix in the forward direction is denoted by code i_{L}, and the image of the right matrix in the reverse direction is denoted by code i_{R}.

In step F3, the matrix product calculation unit 13 adds the product of the k′th column block of i_{L} and the k′th row block of i_{R} to the product matrix.

In step F4, loop end processing corresponding to step F2 is performed. Here, when the processing for all the images in the left-right forward direction is completed, the control advances to step F5.

In step F5, the matrix product calculation unit 13 checks whether the conditions k>0 and k<[(K+1)/2] are satisfied.

As a result of the check, if the conditions k>0 and k<[(K+1)/2] are satisfied (see YES route in step F5), the process proceeds to step F6.

In step F6, a loop process is started in which the control up to step F8 is repeated for all images in the left-right forward direction. Note that the image of the left matrix in the reverse direction is denoted by code i′_{L}, and the image of the right matrix in the reverse direction is denoted by code i′_{R}.

In step F7, the matrix product calculation unit 13 adds the product of the k′th column block of i′_{L} and the k′th row block of i′_{R} to the product matrix.

In step F8, loop end processing corresponding to step F6 is performed. Here, when the processing for all the images in the left-right reverse direction is completed, the control advances to step F9.

As a result of the check in step F5, if the conditions of k>0 and k<[(K+1)/2] are not satisfied (see NO route in step F5), the processing of steps F6 to F8 is skipped. Then, the process proceeds to step F9. For example, if there is no communication completed in the reverse direction, the matrix product calculation unit 13 does not perform communication in the reverse direction.

In step F9, loop end processing corresponding to step F1 is performed. Here, when the processing for all K in the left-right forward direction is completed, the processing ends.

Next, the processing in the computer system 1 as an example of the embodiment is exemplified in FIGS. 19 to 26. FIG. 19 is a diagram illustrating an example of a mapping from blocks to processes.

In FIG. 19, a 6×6 DBCSR matrix is divided into 3×3 block grids. Also, an example of mapping the block grid divided in this way to a 3×2 process grid is illustrated.

$$( \begin{matrix}a & c \\ b & d\end{matrix} ) \neq 0 \qquad [ Formula 1 ]$$

The formula 1 is as follows.

The mapping from the blocks to the processes is determined by the {row,col}_dist_block array. For example, in FIG. 19, the hatched block (3,2) indicated by reference P1 is mapped to process (0,0).

Only (1, 3) and (3, 1) blocks are zero blocks, and values of other blocks are non-zero. FIG. 20 is a diagram illustrating data held by each process at the start of matrix product.

In FIG. 20, parentheses for each array are omitted. coo_l is effective only in a case of list_indexing=TRUE, and blk_p, row_p and col_i are effective only in a case of list_indexing=FALSE.

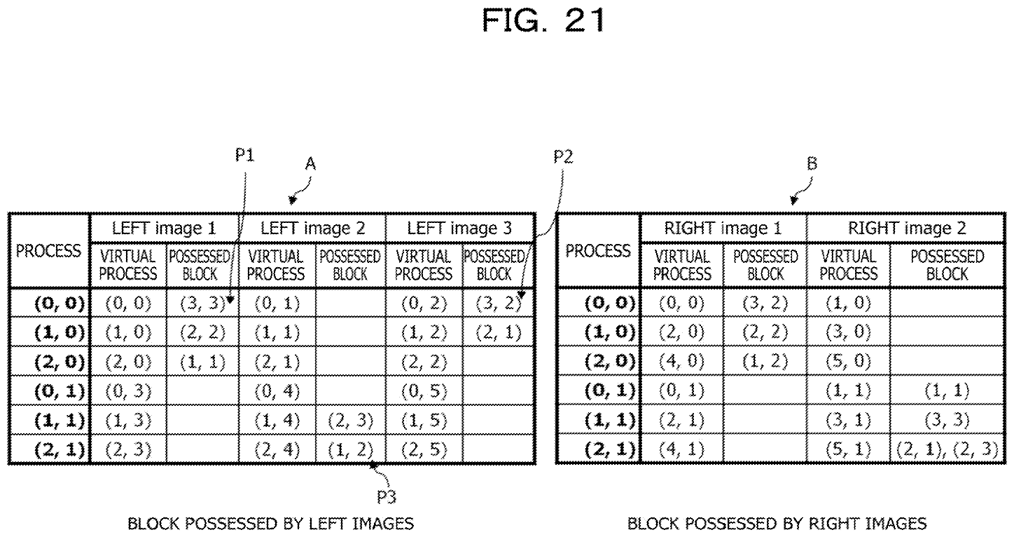

FIG. 21 illustrates images generated by the image generation unit 11.

The image generation unit 11 assumes that the virtual process grid is 6×6 (6=Least common multiple of 2 and 3), and virtual col_dist_block of the left matrix=virtual row_dist_block of the right matrix=[4, 2, 0] is established. The blocks of the left and right matrices are distributed to 3 left images and 2 right images as illustrated in FIG. 21. In FIG. 21, symbol A indicates a block possessed by the left images, and symbol B indicates a block possessed by the right images.

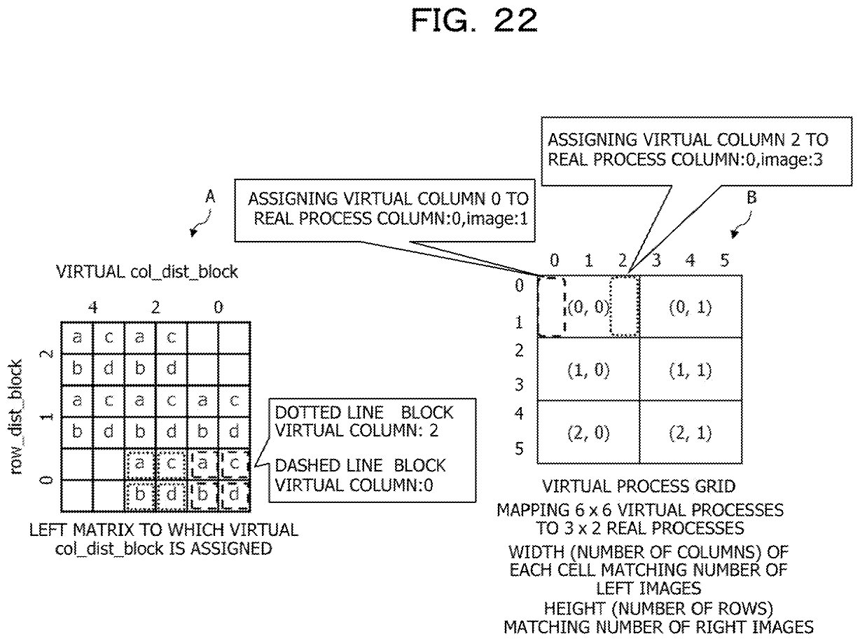

FIG. 22 is a diagram for explaining blocks indicated by symbols P1 and P2 in the images exemplified in FIG. 21.

In FIG. 22, the dashed line portion corresponds to the block indicated by symbol P1 in FIG. 21, and the dotted line portion corresponds to the block indicated by symbol P2 in FIG. 21.

In FIG. 22, symbol A indicates a first-stage map for mapping block positions to virtual columns and exemplifies the left matrix to which virtual col_dist_block is assigned. Symbol B indicates a second-stage map for mapping the virtual columns to real process columns and exemplifies a virtual process grid.

In the virtual process grid indicated by symbol B, 6×6 virtual processes are mapped to 3×2 real processes. The width (number of columns) of each cell matches a number of left images, and the height (number of rows) matches a number of right images.

As illustrated in FIG. 22, the matrix product calculation unit 13 determines a process of a block placement by using the first-stage map for mapping the block positions to the virtual columns and a second-stage map for mapping the virtual columns to the real process columns.

In the example illustrated in FIG. 22, the virtual column does not change due to Cannon matrix product algorithm because of the third block row.

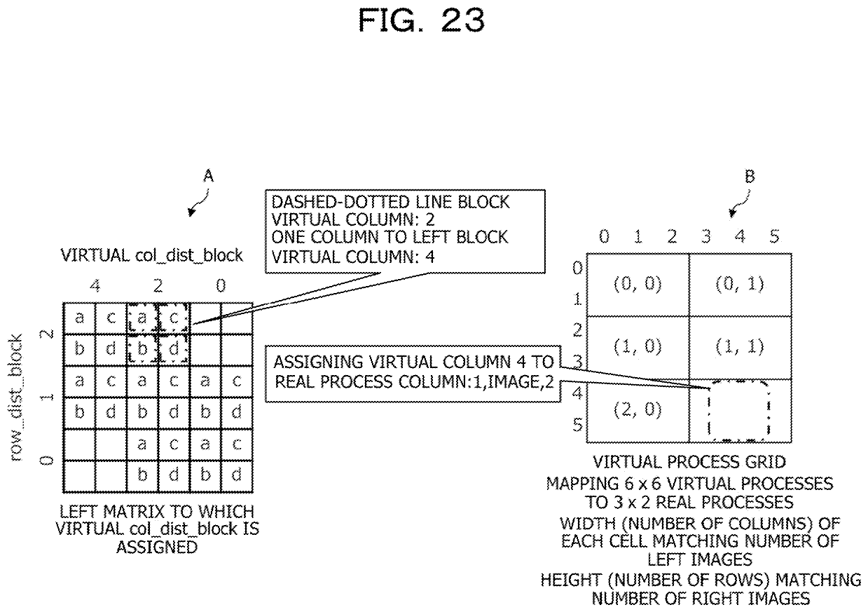

FIG. 23 is a diagram for explaining the block indicated by symbol P3 in the images illustrated in FIG. 21.

In FIG. 23, the dashed-dotted line portion corresponds to the block indicated by symbol P3 in FIG. 21.

In FIG. 23, as in FIG. 22, the 6×6 virtual processes are mapped to the 3×2 real processes in the virtual process grid indicated by symbol B. The width (number of columns) of each cell matches the number of left images, and the height (number of rows) matches the number of right images.

In the example illustrated in FIG. 23, because of the first block row, the real process column is calculated as virtual column 4 one column to the left based on an assumption of an initial state by the Cannon matrix product algorithm. Assuming this initial state, in the Cannon matrix product algorithm, corresponds to obtaining Ci,j of the equation C=AB by repeating steps S1 to S3 described above when the process (i,j) on the two-dimensional process space N×N maintains A_{i,k}, B_{k,j} (k=i+j mod N) of block matrices A and B.

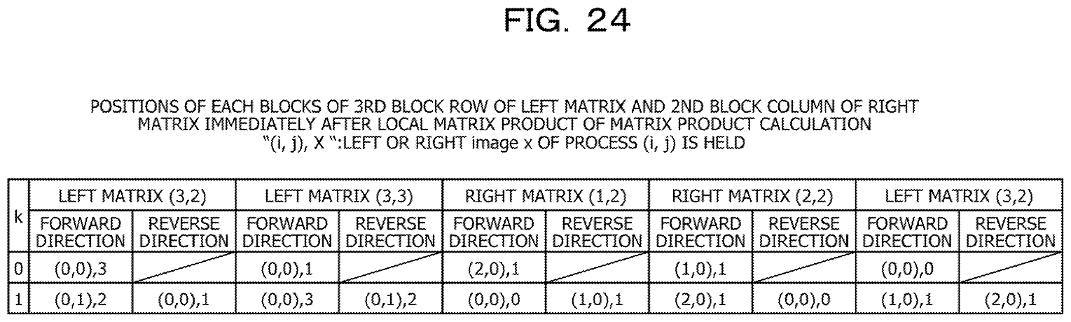

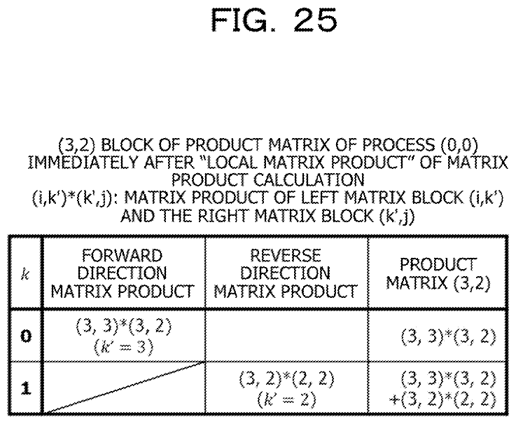

FIG. 24 illustrates positions of each blocks of 3rd block row of the left matrix and 2nd block column of the right matrix immediately after the local matrix product of the matrix product calculation. FIG. 25 illustrates position of (3,2) block of the product matrix of the process (0,0) immediately after the local matrix product of the matrix product calculation.

In these FIGS. 24 and 25, values corresponding to the process (0,0) are extracted and exemplified.

(i, j), x in FIG. 24 indicates that the left or right image x of process (i, j) is held. In addition, (i,k′)*(k′,j) in FIG. 25 indicates the matrix product of the left matrix block (i,k′) and the right matrix block (k′,j).

In the matrix product calculation by the matrix product calculation unit 13, the local matrix product is calculated for k=0, . . . , [K/2]=1 from K=3.

The product matrix is row_dist_block=[2, 1, 0] and col_dist_block=[1, 0, 1].

For example, the process (0, 0) adds a product of blocks, with each other, of the 3rd block row of the left matrix or the 2nd block column of the right matrix which is possessed at k=0 to the product matrix.

At k=1, the left matrix block (3, 2) is received from the own left image 3 and the right matrix block (2, 2) is received from the process (1, 0), and their product is added to the product matrix. As a result, the product of block (3, 2) which the process (0, 0) is in charge of in the product matrix is obtained.

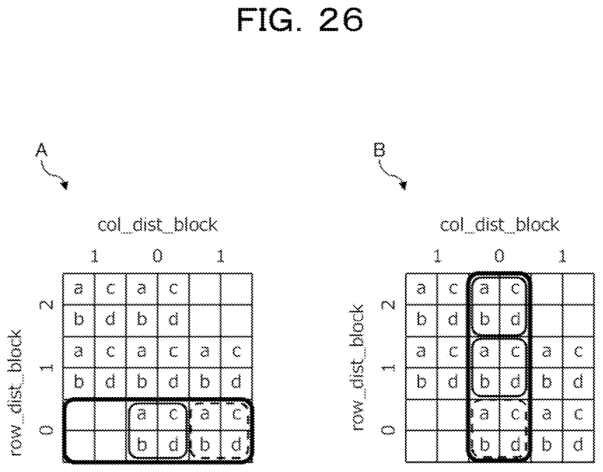

FIG. 26 illustrates a part in charge of process (0, 0) in the block grid surrounded by a thick line.

In FIG. 26, symbol A indicates a left matrix block grid, and symbol B indicates a right matrix block grid.

In FIG. 26, areas surrounded by the thick line indicate all blocks used by the process (0,0) for the matrix product calculation. Also, in FIG. 26, areas surrounded by thin lines indicate independent blocks among the all blocks used by the process (0,0). Furthermore, a dashed line part exemplifies a block held by a same process immediately after image generation by the image generation unit 11.

The matrix product calculation unit 13 receives the blocks surrounded by thin lines in FIG. 26, calculates the local matrix product, and adds a calculation result to the product matrix to obtain the (3, 2) block of the product matrix.

The matrix product calculation unit 13 transmits/receives the entire data_area, blk_p, row_p, col_i, coo_l in order to transmit/receive blocks of the DBCSR matrix to/from another process.

The algorithm in the computer system 1 allows transmission and reception only in the column or row direction of the process grid. Accordingly, if a certain process holds multiple blocks in an image, the multiple blocks are transmitted to the same process in the same step. Therefore, there is no need to manipulate arrays to decompose them into a plurality of DBCSR matrices or to combine a plurality of DBCSR matrices into one, and the matrix product calculation unit 13 merely transmits/receives the entire arrays. Arrays may be transmitted and received collectively as one or a small number of arrays using offsets for structures and arrays. For example, integer arrays blk_p, row_p, col_i, and coo_l may be held, transmitted and received as one integer array (index), and each array may be manipulated by assigning an offset and accessing using the offset.

{row, col}_dist_block, {row, col}_blk_size and list_indexing do not need to be transmitted or received as {row, col}_dist_block, {row, col}_blk_size and list_indexing do not change during the matrix product.

(C) Effect

As described above, according to the computer system 1 as an example of the embodiment, the matrix product calculation unit 13 bidirectionally and parallelly communicates in the row direction or the column direction of each of the left and right matrices in the Cannon matrix product algorithm. As a result, the utilization efficiency of the network 2 coupling between the nodes 10 (between processes) may be improved, a number of calculation steps may be halved, and the processing performance may be improved.

Further, the communication buffer reservation processing unit 12 further reserves a buffer for two-way communication at high speed using a hash table. This also improves the utilization efficiency of the network 2 that connects between the nodes 10 (between processes).

If the communication buffer table 103 has a communication buffer with a matching hash value, then the communication buffer reservation processing unit 12, if the matrix and the key of the communication buffer match, sets the communication buffer with the matching hash value to be used as the communication buffer. As a result, the communication buffer may be set at high speed, and this also improves the utilization efficiency of the network 2 that couples between the nodes 10 (between processes).

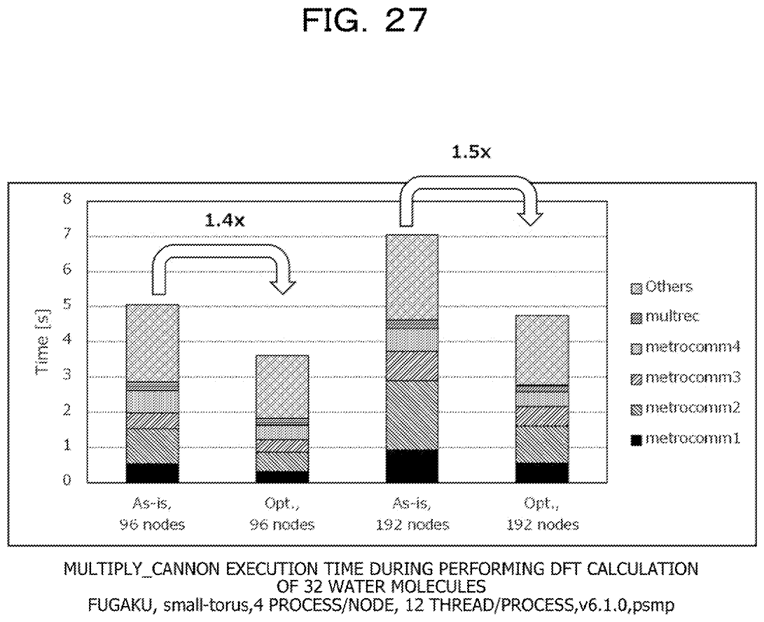

FIG. 27 is a diagram illustrating an example of applying a communication control method to DFT calculation of 32 water molecules (96 atoms) using CP2K application. An execution time of the matrix product (multiply_cannon function) at 192 nodes of supercomputer “Fugaku” is indicated with compared to the time with a related method.

As illustrated in FIG. 27, by applying this communication control method, the execution time of the matrix product (multiply_cannon function) at 96 nodes is speeded up about 1.4 times than that of the related method, and the execution time of the matrix product at 192 nodes is speeded up about 1.5 times than that of the related method, respectively.

In addition, processing times for metrocomms 1 to 4 have been shortened, and it may be seen that these shortened times for transmitting and receiving these data have contributed to shortening the execution time for the matrix product.

(D) Others

Each configuration and each process of this embodiment may be selected as necessary, or may be combined as appropriate. For example, the computer system 1 illustrated in FIG. 1 includes a plurality of nodes 10 and a management server 20, but is not limited to this. At least one node 10 may have the same hardware configuration as the management server 20 and implement the function as the management server 20.

Further, the technology disclosed is not limited to the above-described embodiments, and may be modified in various ways without departing from the gist of the present embodiments.

For example, in the above-described embodiment, an example of using Cannon matrix product algorithm as the matrix multiplication algorithm has been described, but it is not limited to this and may be implemented with appropriate modifications.

In addition, it is possible for a person skilled in the art to implement and manufacture this embodiment based on the above disclosure.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium recording a communication control program for causing a computer to execute a processing of:
processing, by a plurality of information processing devices intercoupled by a multidimensional torus structure, blocks of a matrix in Distributed Block Compressed Sparse Row (DBCSR) format in a plurality of processes in a distributed manner; and
communicating the blocks in both directions for each of a left matrix and a right matrix of the matrix at each stage of a matrix product algorithm.

2. The non-transitory computer-readable recording medium according to claim 1, further comprising:
reserving, as communication buffers, a first transmission-reception buffer for a forward direction communication and a second transmission-reception buffer for a reverse direction communication; and
communicating the blocks in the both directions using the first transmission-reception buffer and the second transmission-reception buffer.

3. The non-transitory computer-readable recording medium according to claim 2, further comprising:
reserving the communication buffers in a hash table for each process in association with hash values which are calculated based on the matrix in the DBCSR format; and
reserving, when a communication buffer for the matrix in the DBCSR format with a matching hash value is registered in the hash table, the communication buffer.

4. The non-transitory computer-readable recording medium according to claim 1, wherein
the matrix product algorithm is a Cannon matrix product algorithm.

5. An information processing apparatus of a plurality of information processing devices intercoupled by a multidimensional torus structure, comprising:
a memory; and
a processor coupled to the memory and configured to:
process blocks of a matrix in Distributed Block Compressed Sparse Row (DBCSR) format in a plurality of processes in a distributed manner; and
communicate the blocks in both directions for each of a left matrix and a right matrix of the matrix at each stage of a matrix product algorithm.

6. The information processing apparatus according to claim 5, wherein: the processor:
reserve, as communication buffers, a first transmission-reception buffer for a forward direction communication and a second transmission-reception buffer for a reverse direction communication; and
communicate the blocks in the both directions using the first transmission-reception buffer and the second transmission-reception buffer.

7. The information processing apparatus according to claim 6, wherein: the processor:
reserve the communication buffers in a hash table for each process in association with hash values which are calculated based on the matrix in the DBCSR format; and
reserve, when a communication buffer for the matrix in the DBCSR format with a matching hash value is registered in the hash table, the communication buffer.

8. The information processing apparatus according to claim 5, wherein
the matrix product algorithm is a Cannon matrix product algorithm.

9. A communication control method comprising:
processing, by a plurality of information processing devices intercoupled by a multidimensional torus structure, blocks of a matrix in Distributed Block Compressed Sparse Row (DBCSR) format in a plurality of processes in a distributed manner; and
communicating the blocks in both directions for each of a left matrix and a right matrix of the matrix at each stage of a matrix product algorithm.

10. The communication control method according to claim 9, further comprising:
reserving, as communication buffers, a first transmission-reception buffer for a forward direction communication and a second transmission-reception buffer for a reverse direction communication; and
communicating the blocks in the both directions using the first transmission-reception buffer and the second transmission-reception buffer.

11. The communication control method according to claim 10, further comprising:
reserving the communication buffers in a hash table for each process in association with hash values which are calculated based on the matrix in the DBCSR format; and
reserving, when a communication buffer for the matrix in the DBCSR format with a matching hash value is registered in the hash table, the communication buffer.

12. The communication control method according to claim 9, wherein
the matrix product algorithm is a Cannon matrix product algorithm.
